(19) United States
(12) Patent Application Publication
(10) Pub. No.: US 2016/0352267 A1
(43) Pub. Date: Dec. 1, 2016

(54) MOTOR DRIVING CIRCUIT AND MOTOR COMPONENT

(71) Applicant: Johnson Electric S.A., Murten (CH)

(72) Inventors: Chi Ping SUN, Hong Kong (CN); Shing Hin YEUNG, Hong Kong (CN); Fei XIN, Shen Zhen (CN); Xiu Wen YANG, Shen Zhen (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Li Sheng LIU, Shen Zhen (CN); Yan Yun CUI, Shen Zhen (CN)

(21) Appl. No.: 15/231,311

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN2015/086422, filed on Aug. 7, 2015.

(30) Foreign Application Priority Data
Aug. 8, 2014 (CN) 201410390592.2
Aug. 15, 2014 (CN) 201410404474.2
Jun. 20, 2016 (CN) 201610447131.3

(51) Int. Cl. H02P 6/16; H02P 6/26; H02K 21/00; H02K 1/27; H02K 11/215

(52) U.S. Cl. CPC H02P 6/16; H02K 1/2706; H02K 11/215; H02K 21/00; H02P 6/26

(57) ABSTRACT

A motor driving circuit and a motor component are provided. The motor driving circuit includes: a bidirectional alternating current switch connected in series with a motor across two terminals of an external alternating current power supply, where the bidirectional alternating current switch is connected between a first node and a second node; a rectifying circuit having a first input terminal and a second input terminal; a first voltage drop circuit connected between the first input terminal of the rectifying circuit and the first node; a switch control circuit connected between a control terminal of the bidirectional alternating current switch and an output terminal of the rectifying circuit; and a magnetic sensor, where an output terminal of the magnetic sensor is connected to a control terminal of the switch control circuit, and the magnetic sensor is configured to detect a magnetic field of a rotor of the motor and output a corresponding magnetic inductive signal. In this way, the motor with the motor driving circuit starts to rotate in a fixed direction every time the rotor is powered on.

### CROSS REFERENCE TO RELATED APPLICATIONS

This application is a continuation-in-part of co-pending U.S. patent application Ser. No. 14/822,353, filed on Aug. 10, 2015, which claims priority under 35 U.S.C. §119(a) from Patent Application No. 201410390592.2 filed in the People's Republic of China on Aug. 8, 2014, and Patent Application No. 201410404474.2 filed in the People's Republic of China on Aug. 15, 2014; this application claims priority under 35 U.S.C. §119(a) from Patent Application No. 201610447131.3 filed in the People's Republic of China on Jun. 20, 2016, Patent Application No. PCTCN2015086422 as PCT application filed in Receiving Office of CN on Aug. 7, 2015, all of which are expressly incorporated herein by reference in their entireties and for all purposes.

### TECHNICAL FIELD

The present disclosure relates to the field of motor driving technology, and in particular to a motor driving circuit and a motor component.

### BACKGROUND

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. To ensure the starting of a conventional synchronous motor, a starting point of the motor is set to be low, which results in that the motor cannot operate at a relatively high working point, thus the efficiency is low. In another aspect, the rotor cannot be ensured to rotate in a same direction every time since a stop or stationary position of the permanent magnetic rotor is not fixed. Accordingly, in applications such as a fan and water pump, the impeller driven by the rotor has straight radial vanes, which results in a low operational efficiency of the fan and water pump.

FIG. 1 illustrates a conventional drive circuit for a synchronous motor, which allows a rotor to rotate in a same predetermined direction in every time it starts. In the circuit, a stator winding 1 of the motor is connected in series with a TRIAC between two terminals M and N of an AC power source VM, and an AC power source VM is converted by a conversion circuit DC into a direct current voltage and the direct current is supplied to a position sensor H. A magnetic pole position of a rotor in the motor is detected by the position sensor H, and an output signal Vh of the position sensor H is connected to a switch control circuit PC to control the bidirectional thyristor T.

FIG. 2 illustrates a waveform of the drive circuit. It can be seen from FIG. 2 that, in the drive circuit, no matter the bidirectional thyristor T is switched on or off, the AC power source supplies power for the conversion circuit DC so that the conversion circuit DC constantly outputs and supplies power for the position sensor H (referring to a signal VH in FIG. 2). In a low-power application, in a case that the AC power source is commercial electricity of about 200V, the electric energy consumed by two resistors R2 and R3 in the conversion circuit DC is more than the electric energy consumed by the motor.

The magnetic sensor applies Hall effect, in which, when current I runs through a substance and a magnetic field B is applied in a positive angle with respect to the current I, a potential difference V is generated in a direction perpendicular to the direction of current I and the direction of the magnetic field B. The magnetic sensor is often implemented to detect the magnetic polarity of an electric rotor.

As the circuit design and signal processing technology advances, there is a need to improve the magnetic sensor integrated circuit for the ease of use and accurate detection.

### BRIEF DESCRIPTION OF THE DRAWINGS

In order to illustrate technical solutions in embodiments of the present disclosure or in the conventional technology more clearly, drawings used in the description of the embodiments or the conventional technology are introduced briefly hereinafter. Apparently, the drawings described hereinafter merely illustrate some embodiments of the present disclosure, and other drawings may be obtained by those skilled in the art based on these drawings without any creative efforts.

FIG. 1 illustrates a prior art drive circuit for a synchronous motor, according to an embodiment of the present disclosure;

FIG. 2 illustrates a waveform of the drive circuit shown in FIG. 1;

FIG. 3 illustrates a diagrammatic representation of a synchronous motor, according to an embodiment of the present disclosure;

FIG. 4 illustrates a block diagram of a drive circuit for a synchronous motor, according to an embodiment of the present disclosure;

FIG. 5 illustrates a drive circuit for a synchronous motor, according to an embodiment of the present disclosure;

FIG. 6 illustrates a waveform of the drive circuit shown in FIG. 5;

FIG. 7 to 10 illustrate different embodiments of a drive circuit of a synchronous motor, according to an embodiment of the present disclosure;

FIG. 11A is a structural diagram of a motor driving circuit according to an embodiment of the present disclosure;

FIG. 11B is a structural diagram of a motor driving circuit according to another embodiment of the present disclosure;

FIG. 12 is a structural diagram of a motor driving circuit according to still another embodiment of the present disclosure;

FIG. 13 is a structural diagram of a switch control circuit according to an embodiment of the present disclosure;

FIG. 14 is a structural diagram of a switch control circuit according to another embodiment of the present disclosure;

FIG. 15A is a structural diagram of a switch control circuit according to still another embodiment of the present disclosure;

FIG. 15B is a structural diagram of a switch control circuit according to yet another embodiment of the present disclosure;

FIG. 16 is a structural diagram of a rectifying circuit in a motor driving circuit according to an embodiment of the present disclosure;

FIG. 17 is a structural diagram of a magnetic sensor in a motor driving circuit according to an embodiment of the present disclosure;

FIG. 18 is a structural diagram of a motor in a motor component according to an embodiment of the present disclosure; and

FIG. 19A to FIG. 19D are schematic diagrams of a current path of a motor driving circuit for different polarities of a power supply and different polarities of a magnetic field according to embodiments of the present disclosure.

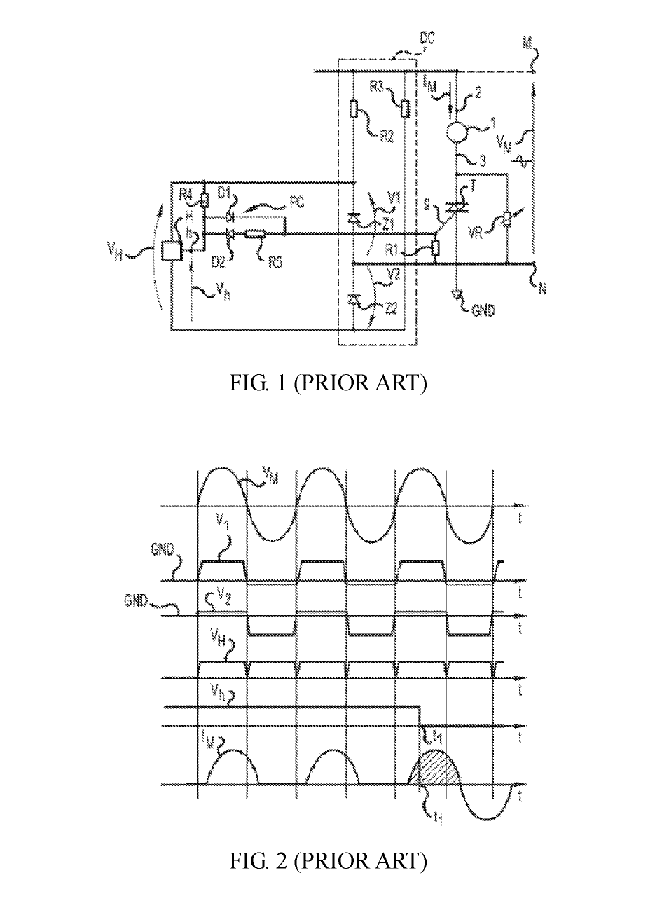

### DETAILED DESCRIPTION OF THE EMBODIMENTS

The technical solutions according to embodiments of the present disclosure are clearly and completely described hereinafter in conjunction with the drawings according to the embodiments of the present disclosure. Apparently, the described embodiments are only a few rather than all of the embodiments of the present disclosure. All other embodiments obtained by those ordinarily skilled in the art based on the embodiments of the present disclosure without any creative efforts fall within the protection scope of the present disclosure.

Specific details are set forth in the following descriptions for sufficient understanding of the present disclosure, but the present disclosure may further be implemented in other ways different from the ways described herein. Similar extensions can be made by those skilled in the art without departing from the spirit of the present disclosure, and therefore, the present disclosure is not limited to particular embodiments disclosed hereinafter.

Hereinafter, a motor driving circuit according to embodiments of the present disclosure is illustrated by taking the motor driving circuit applied to a motor as an example.

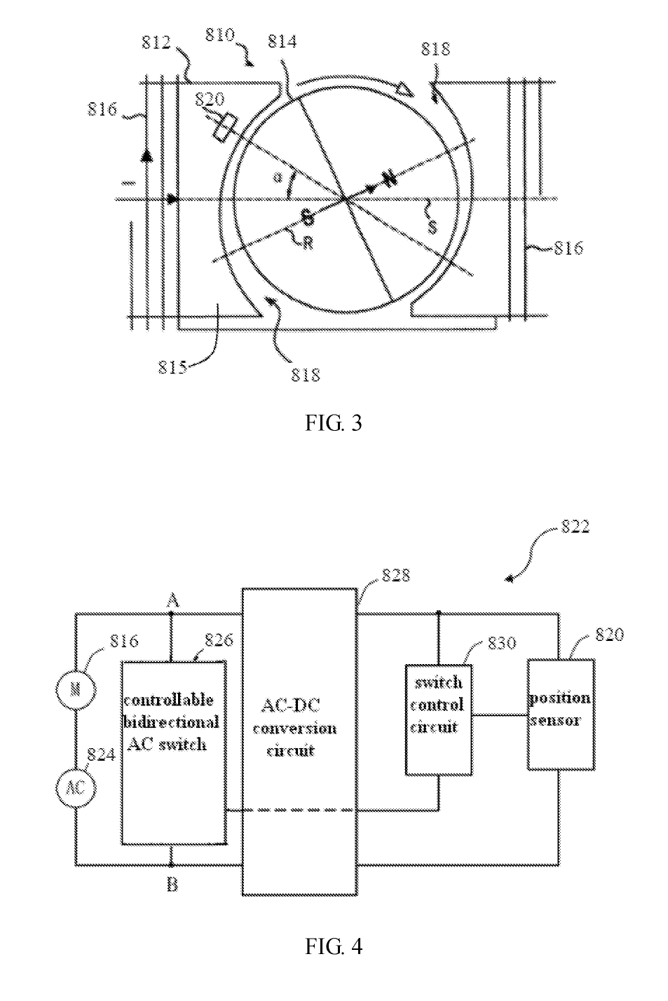

FIG. 3 schematically shows a synchronous motor according to an embodiment of the present invention. The synchronous motor 810 includes a stator 812 and a permanent magnet rotor 814 rotatably disposed between magnetic poles of the stator 812, and the stator 812 includes a stator core 815 and a stator winding 816 wound on the stator core 815. The rotor 814 includes at least one permanent magnet forming at least one pair of permanent magnetic poles with opposite polarities, and the rotor 814 operates at a constant rotational speed of 60f/p rpm during a steady state phase in a case that the stator winding 816 is connected to an AC power supply, where f is a frequency of the AC power supply and p is the number of pole pairs of the rotor.

Non-uniform gap 818 is formed between the magnetic poles of the stator 812 and the permanent magnetic poles of the rotor 814 so that a polar axis R of the rotor 814 has an angular offset a relative to a central axis S of the stator 812 in a case that the rotor is at rest. The rotor 814 may be configured to have a fixed starting direction (a clockwise direction in this embodiment as shown by the arrow in FIG. 3) every time the stator winding 816 is energized. The stator and the rotor each have two magnetic poles as shown in FIG. 3. It can be understood that, in other embodiments, the stator and the rotor may also have more magnetic poles, such as 4 or 6 magnetic poles.

A position sensor 820 for detecting the angular position of the rotor is disposed on the stator 812 or at a position near the rotor inside the stator, and the position sensor 820 has an angular offset relative to the central axis S of the stator. Preferably, this angular offset is also a, as in this embodiment. Preferably, the position sensor 820 is a Hall effect sensor.

FIG. 4 shows a block diagram of a drive circuit for a synchronous motor according to an embodiment of the present invention. In the drive circuit 822, the stator winding 816 and the AC power supply 824 are connected in series between two nodes A and B. Preferably, the AC power supply 824 may be a commercial AC power supply with a fixed frequency, such as 50 Hz or 60 Hz, and a supply voltage may be, for example, 110V, 220V or 230V. A controllable bidirectional AC switch 826 is connected between the two nodes A and B, in parallel with the stator winding 816 and the AC power supply 824. Preferably, the controllable bidirectional AC switch 826 is a TRIAC, of which two anodes are connected to the two nodes A and B respectively. It can be understood that, the controllable bidirectional AC switch 826 alternatively may be two silicon control rectifiers reversely connected in parallel, and control circuits may be correspondingly configured to control the two silicon control rectifiers in a preset way. An AC-DC conversion circuit 828 is also connected between the two nodes A and B. An AC voltage between the two nodes A and B is converted by the AC-DC conversion circuit 828 into a low voltage DC. The position sensor 820 may be powered by the low voltage DC output by the AC-DC conversion circuit 828, for detecting the magnetic pole position of the permanent magnet rotor 814 of the synchronous motor 810 and outputting a corresponding signal. A switch control circuit 830 is connected to the AC-DC conversion circuit 828, the position sensor 820 and the controllable bidirectional AC switch 826, and is configured to control the controllable bidirectional AC switch 826 to be switched between a switch-on state and a switch-off state in a predetermined way, based on the magnetic pole position of the permanent magnet rotor which is detected by the position sensor and polarity information of the AC power supply 824 which may be obtained from the AC-DC conversion circuit 828, such that the stator winding 816 urges the rotor 814 to rotate only in the above-mentioned fixed starting direction during a starting phase of the motor. According to this embodiment of the present invention, in a case that the controllable bidirectional AC switch 826 is switched on, the two nodes A and B are shorted, the AC-DC conversion circuit 828 does not consume electric energy since there is no current flowing through the AC-DC conversion circuit 828, hence, the utilization efficiency of electric energy can be improved significantly.

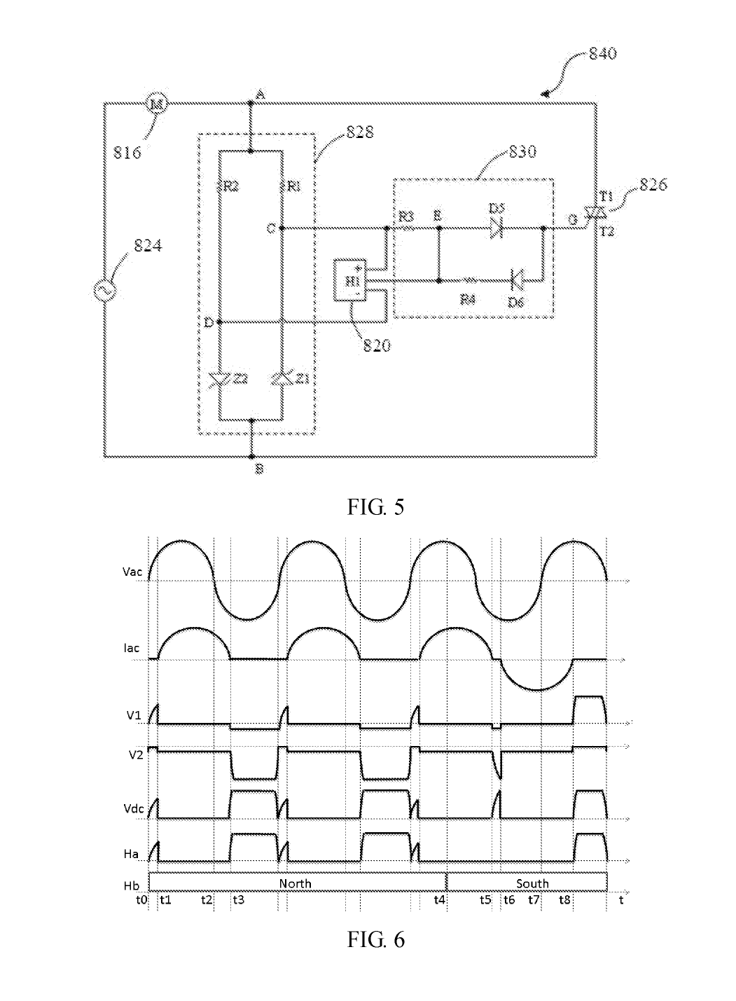

FIG. 5 shows a circuit diagram of a drive circuit 840 for a synchronous motor according to a first embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC (preferably, low voltage ranges from 3V to 18V). The AC-DC conversion circuit 828 includes a first zener diode Z1 and a second zener diode Z2 which are reversely connected in parallel between the two nodes A and B via a first resistor R1 and a second resistor R2 respectively. A high voltage output terminal C of the AC-DC conversion circuit 828 is formed at a connection point of the first resistor R1 and a cathode of the first zener diode Z1, and a low voltage output terminal D of the AC-DC conversion circuit 828 is formed at a connection point of the second resistor R2 and an anode of the second zener diode Z2. The voltage output terminal C is connected to a positive power supply terminal of the position sensor 820, and the voltage output terminal D is connected to a negative power supply terminal of the position sensor 820. Three terminals of the switch control circuit 830 are connected to the high voltage output terminal C of the AC-DC conversion circuit 828, an output terminal H1 of the position sensor 820 and a control electrode G of the TRIAC 826 respectively. The switch control circuit 830 includes a third resistor R3, a fifth diode D5, and a fourth resistor R4 and a sixth diode D6 connected in series between the output terminal HI of the position sensor 820 and the control electrode G of the controllable bidirectional AC switch 826. An anode of the sixth diode D6 is connected to the control electrode G of the controllable bidirectional AC switch 826. One terminal of the third resistor R3 is connected to the high voltage output terminal C of the AC-DC conversion circuit 828, and the other terminal of the third resistor R3 is connected to an anode of the fifth diode D5. A cathode of the fifth diode D5 is connected to the control electrode G of the controllable bidirectional AC switch 826.

In conjunction with FIG. 6, an operational principle of the drive circuit 840 is described. In FIG. 6, Vac indicates a waveform of voltage of the AC power supply 824, and lac indicates a waveform of current flowing through the stator winding 816. Due to the inductive character of the stator winding 816, the waveform of current Iac lags behind the waveform of voltage Vac. V1 indicates a waveform of voltage between two terminals of the first zener diode Z1, V2 indicates a waveform of voltage between two terminals of the second zener diode Z2, Vdc indicates a waveform of voltage between two output terminals C and D of the AC-DC conversion circuit 828, Ha indicates a waveform of a signal output by the output terminal H1 of the position sensor 820, and Hb indicates a rotor magnetic field detected by the position sensor 820. In this embodiment, in a case that the position sensor 820 is powered normally, the output terminal HI outputs a logic high level in a case that the detected rotor magnetic field is North, or the output terminal H1 outputs a logic low level in a case that the detected rotor magnetic field is South.

In a case that the rotor magnetic field Hb detected by the position sensor 820 is North, in a first positive half cycle of the AC power supply, the supply voltage is gradually increased from a time instant t0 to a time instant t1, the output terminal H1 of the position sensor 820 outputs a high level, and a current flows through the resistor R1, the resistor R3, the diode D5 and the control electrode G and the second anode T2 of the TRIAC 826 sequentially. The TRIAC 826 is switched on in a case that a drive current flowing through the control electrode G and the second anode T2 is greater than a gate triggering current Ig. Once the TRIAC 826 is switched on, the two nodes A and B are shorted, a current flowing through the stator winding 816 in the motor is gradually increased until a large forward current flows through the stator winding 816 to drive the rotor 814 to rotate clockwise as shown in FIG. 3. Since the two nodes A and B are shorted, there is no current flowing through the AC-DC conversion circuit 28 from the time instant t1 to a time instant t2. Hence, the resistors R1 and R2 do not consume electric energy, and the output of the position sensor 820 is stopped due to no power is supplied. Since the current flowing through two anodes T1 and T2 of the TRIAC 826 is large enough (which is greater than a holding current Ihold), the TRIAC 826 is kept to be switched on in a case that there is no drive current flowing through the control electrode G and the second anode T2. In a negative half cycle of the AC power supply, after a time instant t3, a current flowing through T1 and T2 is less than the holding current Ihold, the TRIAC 826 is switched off, a current begins to flow through the AC-DC conversion circuit 828, and the output terminal HI of the position sensor 820 outputs a high level again. Since a potential at the point C is lower than a potential at the point E, there is no drive current flowing through the control electrode G and the second anode T2 of the TRIAC 826, and the TRIAC 826 is kept to be switched off. Since the resistance of the resistors R1 and R2 in the AC-DC conversion circuit 828 are far greater than the resistance of the stator winding 816 in the motor, a current currently flowing through the stator winding 816 is far less than the current flowing through the stator winding 816 from the time instant t1 to the time instant t2 and generates very small driving force for the rotor 814. Hence, the rotor 814 continues to rotate clockwise due to inertia. In a second positive half cycle of the AC power supply, similar to the first positive half cycle, a current flows through the resistor R1, the resistor R3, the diode D5, and the control electrode G and the second anode T2 of the TRIAC 826 sequentially. The TRIAC 826 is switched on again, and the current flowing through the stator winding 816 continues to drive the rotor 814 to rotate clockwise. Similarly, the resistors R1 and R2 do not consume electric energy since the two nodes A and B are shorted. In the next negative half cycle of the power supply, the current flowing through the two anodes T1 and T2 of the TRIAC 826 is less than the holding current Ihold, the TRIAC 826 is switched off again, and the rotor continues to rotate clockwise due to the effect of inertia.

At a time instant t4, the rotor magnetic field Hb detected by the position sensor 820 changes to be South from North, the AC power supply is still in the positive half cycle and the TRIAC 826 is switched on, the two nodes A and B are shorted, and there is no current flowing through the AC-DC conversion circuit 828. After the AC power supply enters the negative half cycle, the current flowing through the two anodes T1 and T2 of the TRIAC 826 is gradually decreased, and the TRIAC 826 is switched off at a time instant t5. Then the current flows through the second anode T2 and the control electrode G of the TRIAC 826, the diode D6, the resistor R4, the position sensor 820, the resistor R2 and the stator winding 816 sequentially. As the drive current is gradually increased, the TRIAC 826 is switched on again at a time instant t6, the two nodes A and B are shorted again, the resistors RI and R2 do not consume electric energy, and the output of the position sensor 820 is stopped due to no power is supplied. There is a larger reverse current flowing through the stator winding 816, and the rotor 814 continues to be driven clockwise since the rotor magnetic field is South. From the time instant t5 to the time instant t6, the first zener diode Z1 and the second zener diode Z2 are switched on, hence, there is a voltage output between the two output terminals C and D of the AC-DC conversion circuit 828. At a time instant t7, the AC power supply enters the positive half cycle again, the TRIAC 826 is switched off when the current flowing through the TRIAC 826 crosses zero, and then a voltage of the control circuit is gradually increased. As the voltage is gradually increased, a current begins to flow through the AC-DC conversion circuit 828, the output terminal H1 of the position sensor 820 outputs a low level, there is no drive current flowing through the control electrode G and the second anode T2 of the TRIAC 826, hence, the TRIAC 826 is switched off. Since the current flowing through the stator winding 816 is very small, nearly no driving force is generated for the rotor 814. At a time instant t8, the power supply is in the positive half cycle, the position sensor outputs a low level, the TRIAC 826 is kept to be switched off after the current crosses zero, and the rotor continues to rotate clockwise due to inertia. According to an embodiment of the present invention, the rotor may be accelerated to be synchronized with the stator after rotating only one circle after the stator winding is energized.

In the embodiment of the present invention, by taking advantage of a feature of a TRIAC that the TRIAC is kept to be switched on although there is no drive current flowing though the TRIAC once the TRIAC is switched on, it is avoided that a resistor in the AC-DC conversion circuit still consumes electric energy after the TRIAC is switched on, hence, the utilization efficiency of electric energy can be improved significantly.

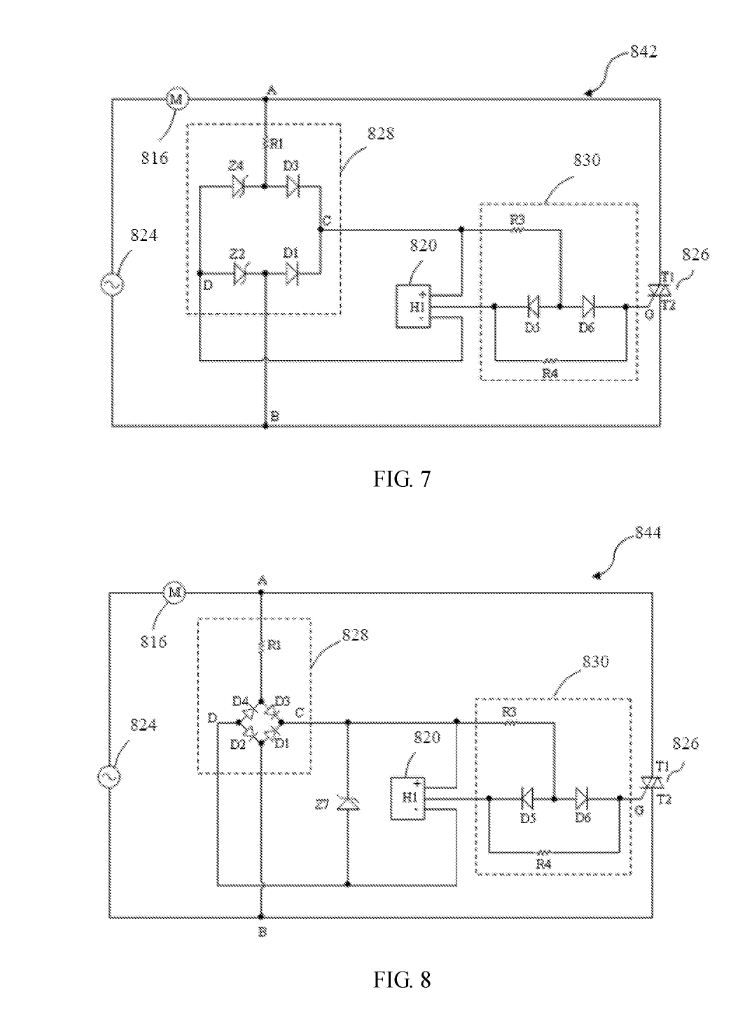

FIG. 7 shows a circuit diagram of a drive circuit 842 for a synchronous motor according to an embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the AC-DC conversion circuit 828 is formed at a connection point of a cathode of the first diode D1 and a cathode of the third diode D3, and the low voltage output terminal D of the AC-DC conversion circuit 828 is formed at a connection point of an anode of the second zener diode Z2 and an anode of the fourth zener diode Z4. The output terminal C is connected to a positive power supply terminal of the position sensor 820, and the output terminal D is connected to a negative power supply terminal of the position sensor 820. The switch control circuit 30 includes a third resistor R3, a fourth resistor R4, and a fifth diode D5 and a sixth diode D6 reversely connected in series between the output terminal H1 of the position sensor 820 and the control electrode G of the controllable bidirectional AC switch 826. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the AC-DC conversion circuit, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

FIG. 8 shows a circuit diagram of a drive circuit 844 for a synchronous motor according to a further embodiment of the present invention. The drive circuit 844 is similar to the drive circuit 842 in the previous embodiment and, the drive circuit 844 differs from the drive circuit 842 in that, the zener diodes Z2 and Z4 in the drive circuit 842 are replaced by general diodes D2 and D4 in the rectifier of the drive circuit 844. In addition, a zener diode Z7 is connected between the two output terminals C and D of the AC-DC conversion circuit 828 in the drive circuit 844.

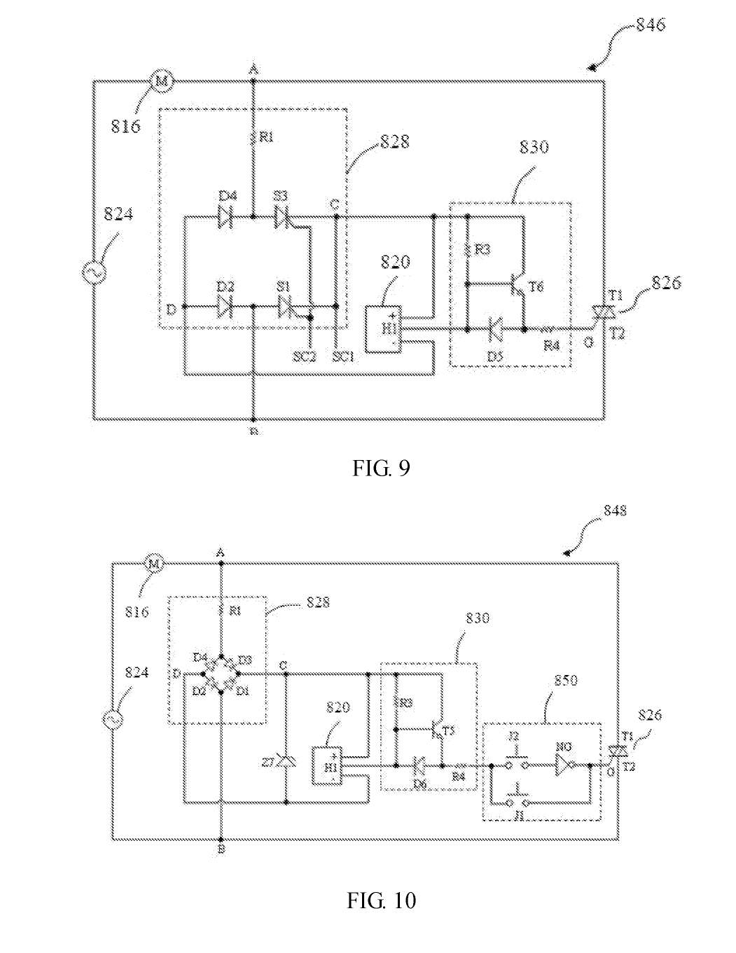

FIG. 9 shows a circuit diagram of a drive circuit 846 for a synchronous motor according to further embodiment of the present invention. The stator winding 816 of the synchronous motor is connected in series with the AC power supply 824 between the two nodes A and B. A first anode Ti of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes two silicon control rectifiers S1 and S3 reversely connected in series, and the other of the two rectifier branches includes a second diode D2 and a fourth diode D4 reversely connected in series. The high voltage output terminal C of the AC-DC conversion circuit 828 is formed at a connection point of a cathode of the silicon control rectifier S1 and a cathode of the silicon control rectifier S3, and the low voltage output terminal D of the AC-DC conversion circuit 828 is formed at a connection point of an anode of the second diode D2 and an anode of the fourth diode D4. The output terminal C is connected to a positive power supply terminal of the position sensor 820, and the output terminal D is connected to a negative power supply terminal of the position sensor 820. The switch control circuit 830 includes a third resistor R3, an NPN transistor T6, and a fourth resistor R4 and a fifth diode D5 connected in series between the output terminal H1 of the position sensor 820 and the control electrode G of the controllable bidirectional AC switch 826. A cathode of the fifth diode D5 is connected to the output terminal H1 of the position sensor. One terminal of the third resistor R3 is connected to the high voltage output terminal C of the AC-DC conversion circuit, and the other terminal of the third resistor R3 is connected to the output terminal H1 of the position sensor. A base of the NPN transistor T6 is connected to the output terminal H1 of the position sensor, an emitter of the NPN transistor T6 is connected to an anode of the fifth diode D5, and a collector of the NPN transistor T6 is connected to the high voltage output terminal C of the AC-DC conversion circuit.

In this embodiment, a reference voltage may be input to the cathodes of the two silicon control rectifiers S1 and S3 via a terminal SC1, and a control signal may be input to control terminals of S1 and S3 via a terminal SC2. The rectifiers Si and S3 are switched on in a case that the control signal input from the terminal SC2 is a high level, or are switched off in a case that the control signal input from the terminal SC2 is a low level. Based on the configuration, the rectifiers S1 and S3 may be switched between a switch-on state and a switch-off state in a preset way by inputting the high level from the terminal SC2 in a case that the drive circuit operates normally. The rectifiers S1 and S3 are switched off by changing the control signal input from the terminal SC2 from the high level to the low level in a case that the drive circuit fails. In this case, the TRIAC 826, the conversion circuit 828 and the position sensor 820 are switched off, to ensure the whole circuit to be in a zero-power state.

FIG. 10 shows a circuit diagram of a drive circuit 848 for a synchronous motor according to another embodiment of the present invention. The drive circuit 848 is similar to the drive circuit 846 in the previous embodiment and, the drive circuit 848 differs from the drive circuit 846 in that, the silicon control diodes S1 and S3 in the drive circuit 846 are replaced by general diodes D1 and D3 in the rectifier of the drive circuit 848, and a zener diode Z7 is connected between the two terminals C and D of the AC-DC conversion circuit 828. In addition, in the drive circuit 848 according to the embodiment, a preset steering circuit 850 is disposed between the switch control circuit 30 and the TRIAC 826. The preset steering circuit 850 includes a first jumper switch J1, a second jumper J2 switch and an inverter NG connected in series with the second jumper switch J2. Similar to the drive circuit 846, in this embodiment, the switch control circuit 830 includes the resistor R3, the resistor R4, the NPN transistor T5 and the diode D6. One terminal of the resistor R4 is connected to a connection point of an emitter of the transistor T5 and an anode of the diode D6, and the other terminal of the resistor R4 is connected to one terminal of the first jumper switch J1, and the other terminal of the first jumper switch J1 is connected to the control electrode G of the TRIAC 826, and the second jumper switch J2 and the inverter NG connected in series are connected across two terminals of the first jumper switch J1. In this embodiment, when the first jumper switch J1 is switched on and the second jumper switch J2 is switched off, similar to the above embodiments, the rotor 814 still starts clockwise; when the second jumper switch J2 is switched on and the first jumper switch J1 is switched off, the rotor 814 starts counterclockwise. In this case, a starting direction of the rotor in the motor may be selected by selecting one of the two jumper switches to be switched on and the other to be switched off. Therefore, in a case that a driving motor is needed to be supplied for different applications having opposite rotational directions, it is just needed to select one of the two jumper switches J1 and J2 to be switched on and the other to be switched off, and no other changes need to be made to the drive circuit, hence, the drive circuit according to this embodiment has good versatility.

As discussed above, the position sensor 820 is configured for detecting the magnetic pole position of the permanent magnet rotor 814 of the synchronous motor 810 and outputting a corresponding signal. The output signal from the position sensor 820 represents some characteristics of the magnetic pole position such as the polarity of the magnetic field associated with the magnetic pole position of the permanent magnet rotor 814 of the synchronous motor 810. The detected magnetic pole position is then used, by the switch control circuit 830, control the controllable bidirectional AC switch 824 to be switched between a switch-on state and a switch-off state in a predetermined way, based on, together with the magnetic pole position of the permanent magnet rotor, the polarity information of the AC power supply 824 which may be obtained from the AC-DC conversion circuit 828. It should be appreciated that the switch control circuit 830 and the position sensor 820 can be realized via magnetic sensing. Accordingly, the present disclosure discloses a magnetic sensor integrated circuit for magnetic sensing and control of a motor according to the sensed information.

The magnetic sensor integrated circuit according to the present disclosure includes a magnetic field detecting circuit that can reliably detect a magnetic field and generate a magnetic induction signal indicative of certain characteristics of the magnetic field. The magnetic sensor as disclosed herein also includes an output control circuit that controls the magnetic sensor to operate in a state determined with respect to the polarity of the magnetic field as well as that of an AC power supply. In the case the magnetic sensor integrated circuit is coupled with the bidirectional AC switch, the magnetic sensor integrated circuit can effectively regulate the operation of the motor via the bidirectional AC switch. Further, the magnetic sensor integrated circuit in the present disclosure may be directly connected to a commercial/residential AC power supply with no need for any additional A/D converting equipment. In this way, the present disclosure of the magnetic sensor integrated circuit is suitable to be used in a wide range of applications.

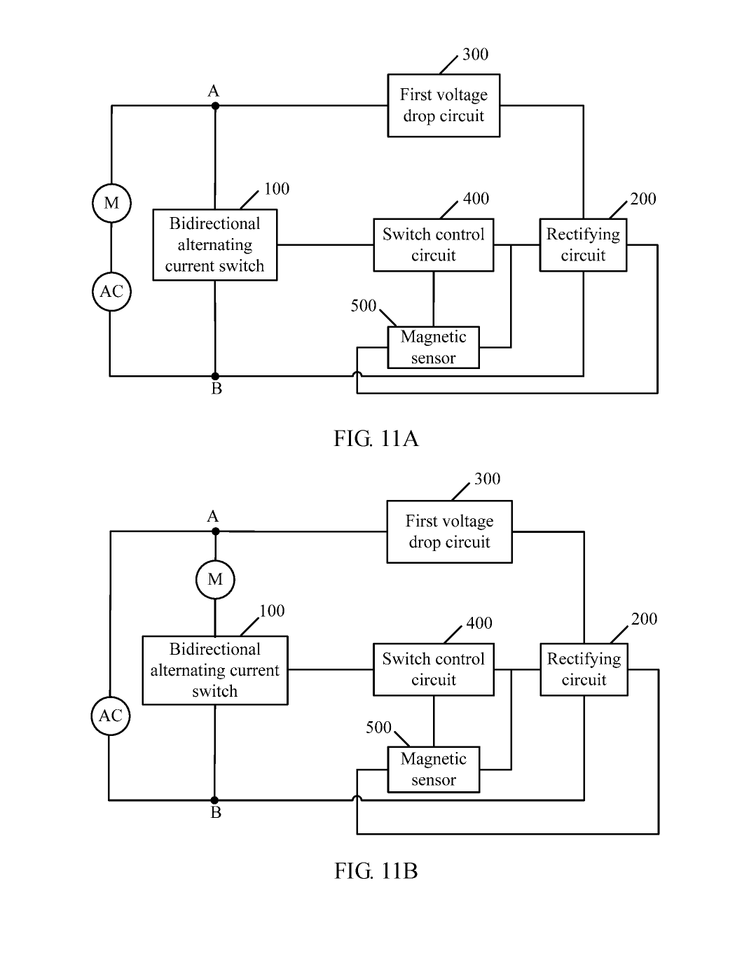

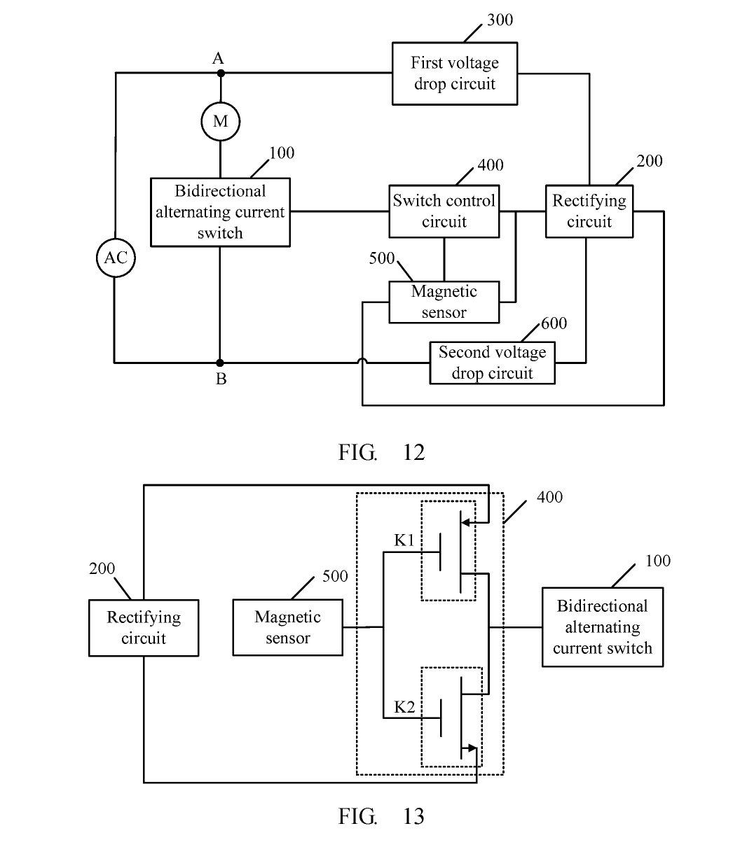

As shown in FIG. 11A and FIG. 11B, a motor driving circuit is provided according to an embodiment of the present disclosure. The motor driving circuit includes a bidirectional alternating current switch 100, a rectifying circuit 200, a first voltage drop circuit 300, a switch control circuit 400, and a magnetic sensor 500.

The bidirectional alternating current switch 100 is connected in series with a motor M across two terminals of an external alternating current power supply AC. The bidirectional alternating current switch 100 may be a triac (TRIAC) and is connected between a first node A and a second node B. Optionally, as shown in FIG. 11A, the motor M is connected in series with the alternating current power supply AC between the first node A and the second node B; or, as shown in FIG. 11B, the motor M is connected in series with the bidirectional alternating current switch 100 between the first node A and the second node B.

The rectifying circuit 200 comprises a first input terminal and a second input terminal and the rectifying circuit 200 is configured to convert an alternating current outputted from the alternating current power supply AC into a direct current and then output the direct current.

The first voltage drop circuit 300 is connected between the first input terminal of the rectifying circuit 200 and the first node A. The types of first voltage drop circuit 300 may be various, depending on specific requirements. For example, the first voltage drop circuit 300 may at least include a first voltage drop resistor RA.

The switch control circuit 400 is connected between a control terminal of the bidirectional alternating current switch 100 and an output terminal of the rectifying circuit 200.

An output terminal of the magnetic sensor 500 is connected to a control terminal of the switch control circuit 400. The magnetic sensor 500 is configured to detect a magnetic field of a rotor of the motor and output a corresponding magnetic inductive signal, and then to change an operation state of the switch control circuit 400 based on the magnetic inductive signal and a current polarity of the alternating current power supply AC. The magnetic sensor 500 is positioned near the rotor of the motor M to sense a variation of the magnetic field of the rotor.

In the technical solutions disclosed in the above embodiment of the present disclosure, the switch control circuit 400 controls states of the bidirectional alternating current switch 100 at least based on the magnetic inductive signal. Control rules can be setting depending on specific requirements, to allow a starting direction of the motor to be controlled by the magnetic inductive signal and the alternating current power supply AC, so that the rotor of the motor M rotates in a same direction every time the motor is started.

It can be understood that, the bidirectional alternating current switch 100 may be implemented with other suitable types of switches. For example, the bidirectional alternating current switch 100 may include two silicon controlled rectifiers connected in anti-parallel with each other, a corresponding control circuit may be provided, and the two silicon controlled rectifiers are controlled in a pre-determined manner via the control circuit based on an output signal of the switch control circuit 400. Or, the bidirectional alternating current switch 100 may include an electronic switch, which allows currents to flow in two directions, consisting of one or more of metal-oxide semiconductor field effect transistor, an AC to DC silicon-controlled conversion circuit, bidirectional triode thyristor, insulated gate bipolar transistor, bipolar junction transistor, thyristor and optocoupler. For example, two metal-oxide semiconductor field effect transistors may constitute a controllable bidirectional alternating current switch; two AC to DC silicon-controlled conversion circuits may constitute a controllable bidirectional alternating current switch; two insulated gate bipolar transistors may constitute a controllable bidirectional alternating current switch; and two bipolar junction transistors may constitute a controllable bidirectional alternating current switch.

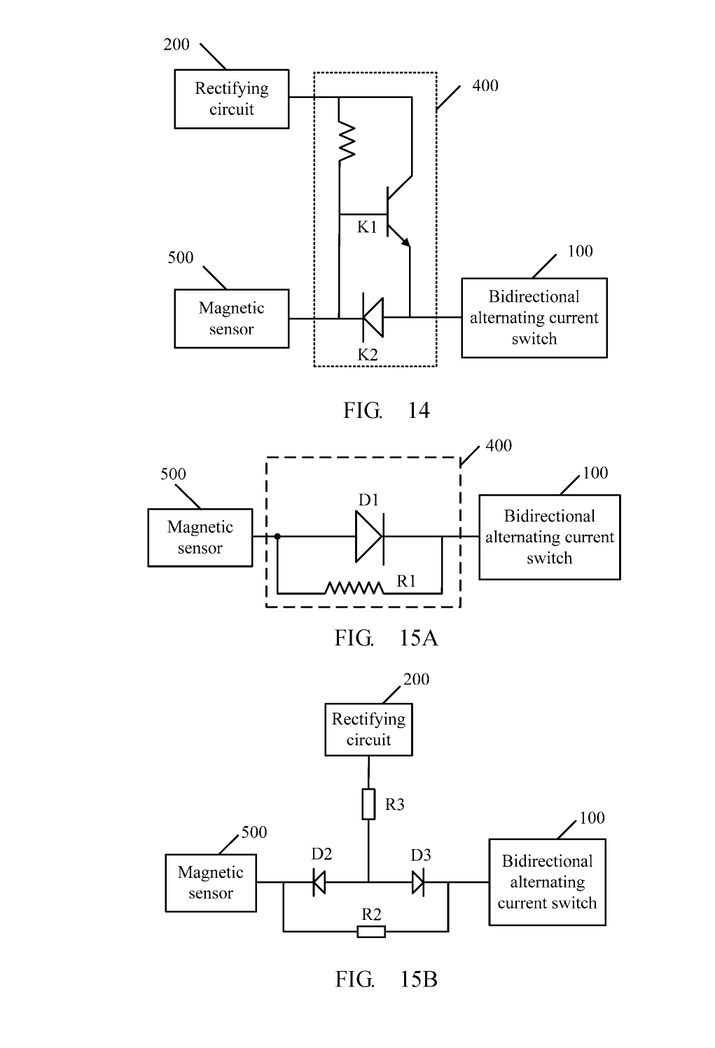

In at least one embodiment of the present disclosure, a drive current of the control terminal of the bidirectional alternating current switch 100 is controlled by a voltage drop generated by the first voltage drop circuit 300. In at least one embodiment, the first voltage drop circuit 300 is provided between the first input terminal of the rectifying circuit 200 and the first node A, and a voltage drop required by the motor driving circuit is totally provided by the first voltage drop circuit 300. For an application requiring a high voltage drop, the first voltage drop circuit 300 has a very high equivalent resistance. When the motor driving circuit is operating, a drive current flowing through the bidirectional alternating current switch 100 will flow through the first voltage drop circuit 300. Therefore, the drive current of the control terminal of the bidirectional alternating current switch 100 will be very small. That is, for selecting the bidirectional alternating current switch 100, it is required to select a type of bidirectional alternating current switch having very small magnitude of drive current. However, a bidirectional alternating current switch meeting the above condition has a very high requirement for fabrication process, directly resulting in a high cost for fabricating a bidirectional alternating current switch which can respond to a low drive current. In another aspect, a bidirectional alternating current switch having a low drive current just can withstand a correspondingly low load current, and can not meet the requirement for an application of a bidirectional alternating current switch having a high load current. In view of the this, the motor driving circuit described above is configured as follows: a current flowing through the first voltage drop circuit 300, in a case that the bidirectional alternating current switch 100 has a drive current, is higher than a current flowing through the first voltage drop circuit 300 in a case that the bidirectional alternating current switch 100 is turned off; and/or a current flowing through the motor M, in a case that the bidirectional alternating current switch 100 has a drive current, is higher than a current flowing through the motor M in a case that the bidirectional alternating current switch 100 is turned off. In a specific implementation of the above configuration solution provided according to the present disclosure, as shown in FIG. 12, the motor driving circuit may further include a second voltage drop circuit 600 provided between the second input terminal of the rectifying circuit 200 and the second node B. Similar to the first voltage drop circuit 300, the second voltage drop circuit 600 may at least include a second voltage drop resistor RB. In this case, the equivalent resistance of the first voltage drop circuit 300 may be reduced properly, so as to increase the drive current of the bidirectional alternating current switch 100. Hence, for selecting the bidirectional alternating current switch 100, a bidirectional alternating current switch having a high drive current and a high load current may be selected, thereby reducing a cost for circuit design. Values of equivalent resistors of the first voltage drop circuit 300 and the second voltage drop circuit 600 may be assigned depending on specific requirements, as long as the first voltage drop circuit 300 and the second voltage drop circuit 600 can provide a proper voltage drop for the motor driving circuit.

In the technical solutions disclosed in the above embodiments of the present disclosure, the switch control circuit 400 is configured to control, based on the magnetic inductive signal and the polarity of the alternating current power supply, the bidirectional alternating current switch 100 to be turned on or turned off. In particular, the bidirectional alternating current switch is turned on, in a case that the alternating current power supply AC is in a positive half-cycle and the magnetic field of the rotor of the motor is in a first polarity or in a case that the alternating current power supply is in a negative half-cycle and the magnetic field of the rotor is in a second polarity opposite to the first polarity, and the bidirectional alternating current switch is turned off, in a case that the alternating current power supply is in a negative half-cycle and the rotor is in the first polarity or in a case that the alternating current power supply is in a positive half-cycle and the rotor is in the second polarity. Which polarity of the magnetic field is the first polarity and which polarity of the magnetic field is the second polarity can be determined based on a starting direction of the rotor as needed.

In the solutions disclosed in the above embodiments of the present disclosure, the switch control circuit 400 may be configured to operate in two states, i.e., a first state and a second state. In a case that the bidirectional alternating current switch 100 is turned on, the switch control circuit 400 at least switches between the first state and the second state. The first state is a state that a current flows from a high voltage output terminal of the rectifying circuit 200 to the control terminal of the bidirectional alternating current switch 100 through the switch control circuit 400; and the second state is a state that a current flows from the control terminal of the bidirectional alternating current switch 100 to a low voltage output terminal of the rectifying circuit 200 through the switch control circuit 400. Specifically, the switch control circuit 400 switches to different states based on different turn-on conditions of the bidirectional alternating current switch 100. For example, if the bidirectional alternating current switch 100 is turned on when the polarity of the magnetic field of the rotor is the first polarity and the alternating current power supply operates in a positive half-cycle, the operating state of the switch control circuit 400 is the first state; and if the bidirectional alternating current switch 100 is turned on when the polarity of the magnetic field of the rotor is the second polarity opposite to the first polarity and the alternating current power supply operates in a negative half-cycle, the operating state of the switch control circuit is the second state.

It should be noted that, when the alternating current power supply is in a positive half-cycle and the external magnetic field is the first polarity, or when the alternating current power supply is in a negative half-cycle and the external magnetic field is the second polarity, a situation that a current flows through the control terminal of the bidirectional alternating current switch 100 may be a situation that a current flows through the control terminal of the bidirectional alternating current switch 100 for whole duration of the two cases (the first state and the second state) described above, or may be a situation that a current flows though the control terminal of the bidirectional alternating current switch 100 for partial duration of the two cases described above.

In at least one embodiment, a case that the switch control circuit 400 switches between the first state and the second state may be a case that the switch control circuit 400 switches to the other state immediately after one state ends, or may be a case that the switch control circuit 400 switches to the other state in a certain time interval after one state ends. In at least one embodiment, there is no current interaction between the switch control circuit 400 and the bidirectional alternating current switch 100 in the time interval between the two states.

The switch control circuit 400 may include a first switch K1 and a second switch K2. The first switch K1 is connected in a first current path and is configured to control, based on the polarity of the magnetic field of the rotor and the polarity of the alternating current power supply, the first current path to be turned on or turned off. The first current path is provided between the control terminal of the bidirectional alternating current switch 100 and the high voltage output terminal of the rectifying circuit 200. The second switch K2 is connected in a second current path and is configured to control, based on the polarity of the magnetic field of the rotor and the polarity of the alternating current power supply, the second current path to be turned on or turned off. The second current path is provided between the control terminal of the bidirectional alternating current switch 100 and the low voltage output terminal of the rectifying circuit 200.

The first current path and the second current path are selectively turned on in alternation under control of the magnetic inductive signal, so that the switch control circuit 400 switches between the first state and the second state. Preferably, the first switch K1 may be a triode, and the second switch K2 may be a triode or a diode, which are not limited in the present disclosure and depend on situations.

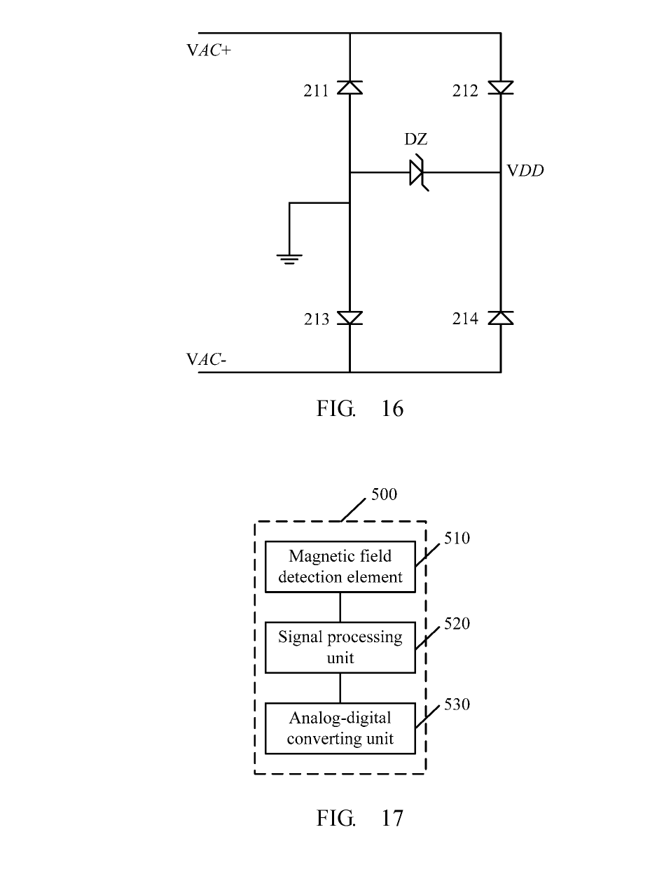

Specifically, in an embodiment of the present disclosure, as shown in FIG. 13, the first switch K1 and the second switch K2 are a pair of complementary semiconductor switches. The first switch K1 is turned on at a low level, and the second switch K2 is turned on at a high level. The first switch K1 is provided in the first current path, and the second switch K2 is provided in the second current path. Both control terminals of the first switch K1 and the second switch K2 are connected to the output terminal of the magnetic sensor 500. A current input terminal of the first switch K1 is connected to the high voltage output terminal of the rectifying circuit 200, a current output terminal of the first switch K1 is connected to a current input terminal of the second switch K2, and a current output terminal of the second switch K2 is connected to the low voltage output terminal of the rectifying circuit 200. If the magnetic inductive signal outputted by the output terminal of the magnetic sensor 500 is at a low level, the first switch K1 is turned on, the second switch K2 is turned off, and a current of the motor driving circuit flows from the high voltage output terminal of the rectifying circuit 200 to the control terminal of the bidirectional alternating current switch 100 through the first switch K1. If the magnetic inductive signal outputted by the output terminal of the magnetic sensor 500 is at a high level, the second switch K2 is turned on, the first switch K1 is turned off, and a load current flows from the control terminal of the bidirectional alternating current switch 100 to the low voltage output terminal of the rectifying circuit 200 through the second switch K2. In at least one embodiment, the first switch K1 is a p-channel metal-oxide semiconductor field effect transistor (P-type MOSFET), and the second switch K2 is an n-channel metal-oxide semiconductor field effect transistor (N-type MOSFET). In other embodiments, the first switch K1 and the second switch K2 may be other types of semiconductor switches, such as a junction field effect transistor (JFET) or a metal semiconductor field effect transistor (MOSFET).

In another embodiment of the present disclosure, as shown in FIG. 14, the first switch K1 is a switch which is turned on at a high level, the second switch K2 is a unidirectional diode, and a control terminal of the first switch K1 and a cathode of the second switch K2 are connected to the output terminal of the magnetic sensor 500. A current input terminal of the first switch K1 is connected to the high voltage output terminal of the rectifying circuit 200, and a current output terminal of the first switch K1 and an anode of the second switch K2 are connected to the control terminal of the bidirectional alternating current switch 100. The first switch K1 is connected in the first current path, and the second switch K2 and the magnetic sensor 500 are connected in the second current path. In a case that the magnetic inductive signal outputted by the output terminal of the magnetic sensor 500 is at a high level, the first switch K1 is turned on, the second switch K2 is turned off, and a current of the motor driving circuit flows from the high voltage output terminal of the rectifying circuit 200 to the control terminal of the bidirectional alternating current switch 100 through the first switch K1. In a case that the magnetic inductive signal outputted by the output terminal of the magnetic sensor 500 is at a low level, the second switch K2 is turned on, the first switch K1 is turned off, and a current of the motor driving circuit flows from the control terminal of the bidirectional alternating current switch 100 to the low voltage output terminal of the rectifying circuit 200 through the second switch K2 and the magnetic sensor 500 in sequence. In other embodiments of the present disclosure, the first switch K1 and the second switch K2 may be of other structures, which are not limited in the present disclosure and depend on specific situations.

In another embodiment of the present disclosure, the switch control circuit 400 includes a first current path in which a current flows to the control terminal of the bidirectional alternating current switch, a second current path in which a current flows from the control terminal of the bidirectional alternating current switch, and a switch connected in one of the first current path and the second current path. The switch is controlled by the magnetic inductive signal to turn on the first current path and the second current path selectively. Preferably, there is no switch in the other one of the first current path and the second current path.

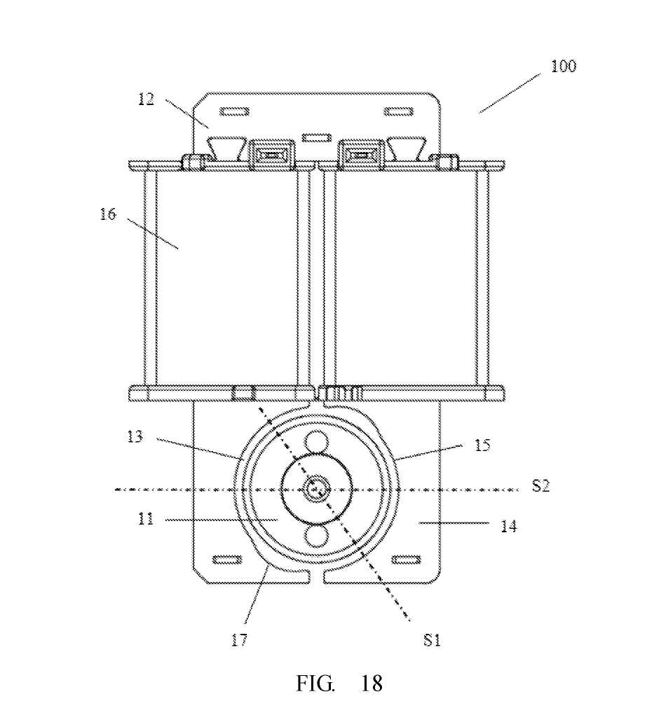

In a specific implementation, as shown in FIG. 15A, the switch control circuit 400 includes a unidirectional switch D1 and a resistor R1 connected in parallel. A current input terminal of the unidirectional switch D1 is connected to the output terminal of the magnetic sensor 500, and a current output terminal of the unidirectional switch D1 is connected to the control terminal of the bidirectional alternating current switch 100. The magnetic sensor 500 and the unidirectional switch D1 are connected in a current path in which a current flows from the high voltage output terminal of the rectifying circuit 200 to the control terminal of the bidirectional alternating current switch 100, and the magnetic sensor 500 and the resistor R1 are provided in a current path in which a current flows from the control terminal of the bidirectional alternating current switch 100 to the low voltage output terminal of the rectifying circuit 200. The unidirectional switch D1 is turned on in a case that the magnetic inductive signal is at a high level, and a current of the motor driving circuit flows from the high voltage output terminal of the rectifying circuit 200 to the control terminal of the bidirectional alternating current switch 100 through the magnetic sensor 500 and the unidirectional switch D1 in sequence. In a case that the magnetic inductive signal is at a low level, the unidirectional switch D1 is turned off, and the current of the motor driving circuit flows from the control terminal of the bidirectional alternating current switch 100 to the low voltage output terminal of the rectifying circuit 200 through the resistor R1 and the magnetic sensor 500 in sequence.

In another specific implementation, as shown in FIG. 15B, the switch control circuit 400 includes diodes D2 and D3 connected in anti-series between the output terminal of the magnetic sensor 500 and the control terminal of the bidirectional alternating current switch, a resistor R2 connected in parallel with the series-connected diodes D2 and D3, and a resistor R3 connected between a common terminal of the diodes D2 and D3 and the high voltage output terminal of the rectifying circuit 200. A cathode of the diode D2 is connected to the output terminal of the magnetic sensor 500. The diode D2 is controlled by the magnetic inductive signal. In a case that the magnetic inductive signal is at a high level, the diode D2 is turned off, and a current of the motor driving circuit flows from the high voltage output terminal of the rectifying circuit 200 to the control terminal of the bidirectional alternating current switch 100 though the resistor R3 and the diode D3 in sequence. In a case that the magnetic inductive signal is at a low level, the current of the motor driving circuit flows from the control terminal of the bidirectional alternating current switch 100 to the low voltage output terminal of the rectifying circuit 200 through the resistor R2 and the magnetic sensor 500 in sequence.

On the basis of the above embodiments, in an embodiment of the present disclosure, as shown in FIG. 11A or FIG. 11B, an input terminal of the switch control circuit 400 is connected to the high voltage output terminal of the rectifying circuit 200, and an output terminal of the switch control circuit 400 is connected to the control terminal of the bidirectional alternating current switch 100. A power input terminal of the magnetic sensor 500 is connected to the high voltage output terminal of the rectifying circuit 200 directly or indirectly, a grounded terminal of the magnetic sensor 500 is connected to the low voltage output terminal of the rectifying circuit 200, and the output terminal of the magnetic sensor 500 is connected to control terminal of the switch control circuit 400. The motor driving circuit is configured as follows: in a case that the alternating current power supply operates in a positive half-cycle and the polarity of the magnetic field of the rotor is the second polarity, an output of the output terminal of the magnetic sensor 500 prevents the formation of the first current path and the second current path, a path is formed between the power input terminal of the magnetic sensor 500 and the grounded terminal of the magnetic sensor 500, and a current of the motor driving circuit flows to the first node B though the first voltage drop circuit 300, the first input terminal of the rectifying circuit 200, the high voltage output terminal of the rectifying circuit 200, the power input terminal of the magnetic sensor 500, the grounded terminal of the magnetic sensor 500, the low voltage output terminal of the rectifying circuit 200, the second input terminal of the rectifying circuit 200 and the second voltage drop circuit 600 (if the second voltage drop circuit exists) in sequence; in a case that the alternating current power supply operates in a negative half-cycle and the polarity of the magnetic field of the rotor is the first polarity, an output of the output terminal of the magnetic sensor 500 prevents the formation of the first current path and the second current path, a path is formed between the power input terminal of the magnetic sensor 500 and the grounded terminal of the magnetic sensor 500, and the current of the motor driving circuit flows to the first node A though the second voltage drop circuit 600 (if the second voltage drop circuit exists), the second input terminal of the rectifying circuit 200, the low voltage output terminal of the rectifying circuit 200, the grounded terminal of the magnetic sensor 500, the power input terminal of the magnetic sensor 500, the high voltage output terminal of the rectifying circuit 200, the first input terminal of the rectifying circuit 200 and the first voltage drop circuit 300 in sequence; and in a case that the alternating current power supply operates in a negative half-cycle and the polarity of the magnetic field of the rotor is the second polarity, a path is formed between the output terminal of the magnetic sensor 500 and the grounded terminal of the magnetic sensor 500, and in this case, the current of the motor driving circuit flows to the first node A through an input terminal of the bidirectional alternating current switch 100, an output terminal of the bidirectional alternating current switch 100, the output terminal of the switch control circuit 400, the control terminal of the switch control circuit 400, the output terminal of the magnetic sensor 500, the grounded terminal of the magnetic sensor 500, the low voltage output terminal of the rectifying circuit 200, the first input terminal of the rectifying circuit 200 and the first voltage drop circuit 300 in sequence. It should be noted that, “a path formed” between two terminals described in the present disclosure refers to that a current flows through the two terminals, which should not be narrowly interpreted as the two terminals being short-circuited.

In at least one embodiment, in a case that the alternating current power supply operates in a positive half-cycle and the polarity of the magnetic field of the rotor is the first polarity, a path is formed between the input terminal of the switch control circuit 400 and the output terminal of the switch control circuit 400, and in this case, a current of the motor driving circuit flows to the second node B through the first voltage drop circuit 300, the first input terminal of the rectifying circuit 200, the high voltage output terminal of the rectifying circuit 200, the input terminal of the switch control circuit 400, the output terminal of the switch control terminal 400, the control terminal of the bidirectional alternating current switch 100 and the first terminal of the bidirectional alternating current switch 100 in sequence; and in a case that the alternating current power supply operates in a negative half-cycle and the polarity of the magnetic field of the rotor is the second polarity, a path is formed between the output terminal of the switch control circuit 400 and the control terminal of the switch control circuit 400.

In at least one embodiment, the magnetic sensor 500 is powered by a first power supply, and the switch control circuit 400 is powered by a second power supply different from the first power supply. It should be noted that, in the embodiment of the present disclosure, the second power supply may be a power supply with a varying amplitude or may be a direct current power supply with a constant amplitude. In a case that the second power supply is a power supply with a varying amplitude, a direct current power supply with a varying amplitude is preferable, which is not limited in the present disclosure and depends on specific situations.

In at least one embodiment, the first power supply is a direct current power supply with a constant amplitude, to provide a stable drive signal for the magnetic sensor 500 and allow the magnetic sensor 500 to operate steadily.

In at least one embodiment, an average value of an output voltage of the first power supply is less than an average value of an output voltage of the second power supply. It should be noted that, if the magnetic sensor 500 is powered by a power supply with low power consumption, power consumption of the motor driving circuit may be reduced; and if the switch control circuit 400 is powered by a power supply with a high power consumption, the control terminal of the bidirectional alternating current switch 100 may obtain a high current so that the motor driving circuit has a sufficient drive capacity.

In at least one embodiment, the motor driving circuit further includes a voltage regulator circuit provided between the rectifying circuit 200 and the magnetic sensor 500. In the embodiment, the rectifying circuit 200 may be used as the second power supply, and the voltage regulator circuit may be used as the first power supply. The voltage regulator circuit is configured to regulate a first voltage outputted by the rectifying circuit 200 to a second voltage. The second voltage is a supply voltage for the magnetic sensor 500, and the first voltage is a supply voltage for the switch control circuit 400. An average value of the first voltage is greater than an average value of the second voltage, so as to reduce power consumption of the motor driving circuit and allow the motor driving circuit to have a sufficient drive capacity.

In at least one embodiment, the rectifying circuit 200 includes a full wave bridge rectifier and a voltage stabilization unit connected to an output of the full wave bridge rectifier. The full wave bridge rectifier is configured to convert an alternating current outputted by the alternating current power supply AC into a direct current, and the voltage stabilization unit is configured to stabilize a direct current signal outputted by the full wave bridge rectifier within a pre-set value range.

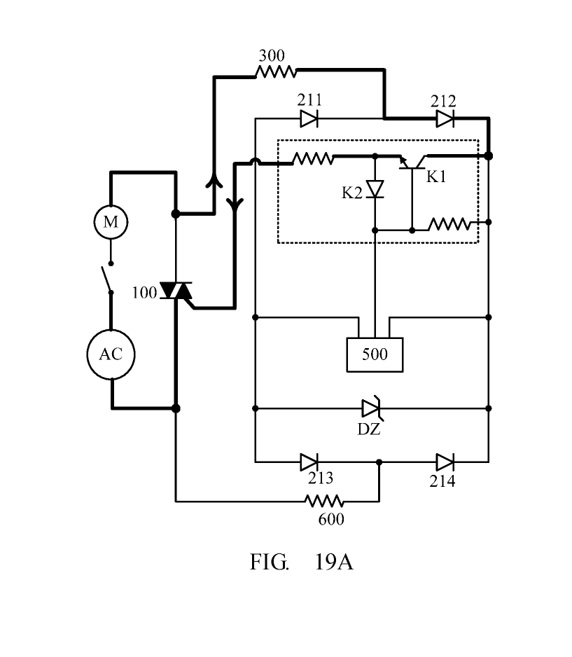

FIG. 16 shows a specific circuit of the rectifying circuit 200. The voltage stabilization unit includes a Zener diode DZ connected between two output terminals of the full wave bridge rectifier. The full wave bridge rectifier includes a first diode 211 and a second diode 212 connected in series and a third diode 213 and a fourth diode 214 connected in series. A common terminal of the first diode 211 and the second diode 212 is connected to the first voltage drop circuit 300. If the motor driving circuit includes the second voltage drop circuit 600, a common terminal of the third diode 213 and the fourth diode 214 is connected to the second voltage drop circuit 600; and if the motor driving circuit does not include the second voltage drop circuit 600, the common terminal of the third diode 213 and the fourth diode 214 is connected to the second node B.

A low voltage output terminal of the full wave bridge rectifier is formed by electrically connecting an input terminal of the first diode 211 to an input terminal of the third diode 213, and a high voltage output terminal of the full wave bridge rectifier is formed by electrically connecting an output terminal of the second diode 212 to an output terminal of the fourth diode 214. The Zener diode DZ is connected between, a common terminal of the second diode 212 and the fourth diode 214, and a common terminal of the first diode 211 and the third diode 213. It should be noted that, in the embodiment of the present disclosure, the input terminal of the switch control circuit 400 is electrically connected to the high voltage output terminal of the full wave bridge rectifier.

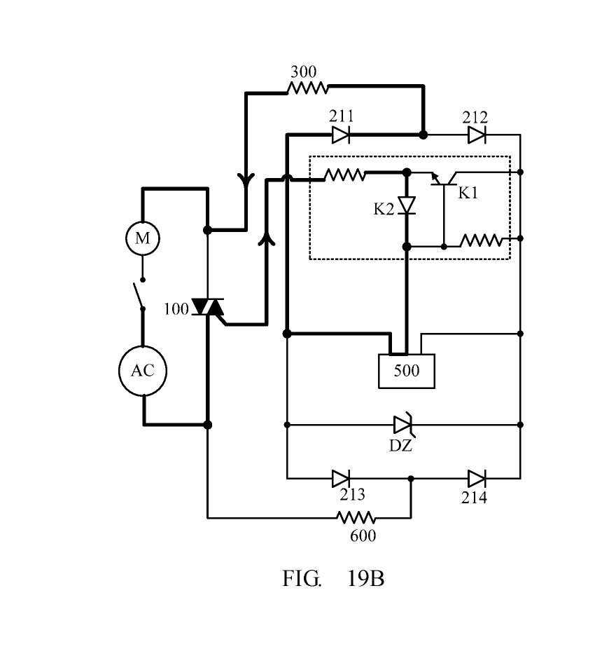

In an embodiment of the present disclosure, as shown in FIG. 17, the magnetic sensor 500 includes a magnetic field detection element 510 configured to detect an external magnetic field and convert the external magnetic field into an electric signal, a signal processing unit 520 configured to amplify and descramble the electric signal, and an analog-digital converting unit 530 configured to convert the amplified and descrambled electric signal into the magnetic inductive signal. For an application to only identify a polarity of the external magnetic field, the magnetic inductive signal may be a switch-type digital signal. Preferably, the magnetic field detection element 510 may be a Hall plate.

In at least one embodiment of the present disclosure, one or more of the rectifying circuit, an output control circuit and a Hall sensor may be integrated in a same integrated circuit.

A motor component is further provided according to an embodiment of the present disclosure. The motor component includes a motor and a motor driving circuit according to any one of the above embodiments.

In at least one embodiment, the motor is a synchronous motor. It can be understood that, the motor driving circuit according to the present disclosure is applicable to a synchronous motor as well as other types of permanent magnet motors such as a brushless direct current motor. As shown in FIG. 18, the synchronous motor includes a stator and a rotor 11 rotatable relative to the stator. The stator includes a stator core 12 and a stator winding 16 wound on the stator core 12. The stator core 12 may be made of soft magnetic materials such as pure iron, cast iron, cast steel, electrical steel, and silicon steel. The rotor 11 includes a permanent magnet, and the rotor 11 operates at a constant rotational speed of 60f/p revs/min in a steady state in a case that the stator winding 16 is connected in series with an alternating current power supply, where the f is a frequency of the alternating current power supply and the p is the number of pole pairs of the rotor. In the embodiment, the stator core 12 includes two poles 14 opposite to each other. Each of the poles includes a pole arc 15. An outside surface of the rotor 11 is opposite to the pole arc 15, and a substantially uniform air gap is formed between the outside surface of the rotor 11 and the pole arc 15. The substantially uniform air gap in the present disclosure refers to that a uniform air gap is formed in most space between the stator and the rotor, and a non-uniformed air gap is formed in a small part of the space between the stator and the rotor. Preferably, a concave starting groove 17 is disposed on the pole arc 15 of the pole of the stator, and the other part of the pole arc 15 except the starting groove 17 is concentric with the rotor. With the configuration described above, an non-uniform magnetic field may be formed, a polar axis S1 of the rotor has an angle of inclination relative to a central axis S2 of the pole of the stator in a case that the rotor is at rest, and the rotor may have a starting torque every time the motor is powered under the action of the motor driving circuit. The pole axis S1 of the rotor refers to a boundary between two magnetic poles of the rotor having different polarities, and the central axis S2 of the pole 14 of the stator refers to a connection line passing through centers of the two poles 14 of the stator. In the embodiment, the stator and the rotor each include two magnetic poles. It can be understood that, in more embodiments, the number of magnetic poles of the stator may not be equal to the number of magnetic poles of the rotor, and the stator and the rotor may have more magnetic poles, such as 4 or 6 magnetic poles.

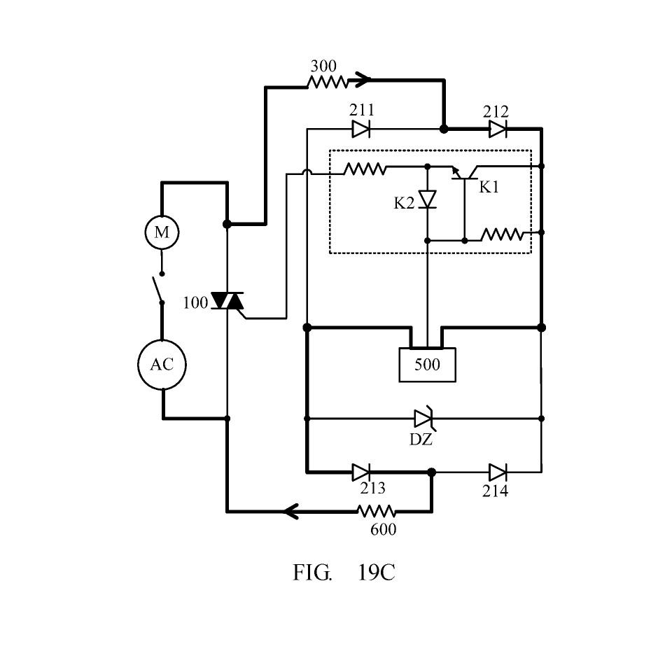

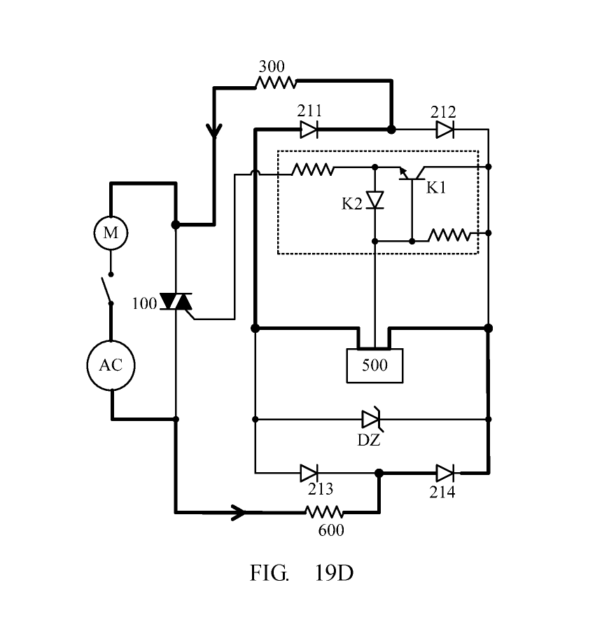

In at least one embodiment, the current input terminal of the first switch K1 in the switch control circuit 400 is connected to a high voltage output terminal of the full wave bridge rectifier, and the current output terminal of the second switch K2 is connected to a low voltage output terminal of the full wave bridge rectifier via the magnetic sensor 500. In a case that a signal outputted by the alternating current power supply AC is in a positive half-cycle and the magnetic sensor 500 outputs a low level, the first switch K1 is turned on and the second switch K2 is turned off in the switch control circuit 400. In this case, as shown in FIG. 19A, a drive current flows to the bidirectional alternating current switch 100 through the alternating current power supply, the motor, a first voltage drop circuit, an output terminal of the second diode 212 of the full wave bridge rectifier, the first switch K1 of the switch control circuit 400 in sequence, and then flows back to the alternating current power supply. The drive current only flows through the first voltage drop circuit 300, and a higher drive current may be obtained by reducing the equivalent resistance of the first voltage drop circuit 300. After the bidirectional alternating current switch 100 is turned on, other circuits are shorted and stop outputting. Since a load current flowing through two anodes of the bidirectional alternating current switch 100 is sufficiently high (higher than a holding current thereof), the bidirectional alternating current switch 100 still remains turned-on even if there is no drive current between the control terminal and a first anode. In a case that the signal outputted by the alternating current power supply is in a negative half-cycle and the magnetic sensor 500 outputs a high level, the first switch K1 is turned off and the second switch K2 is turned on in the switch control circuit 400. As shown in FIG. 19B, a drive current flows from the alternating current power supply, passes through the bidirectional alternating current switch 100, the second switch K2 of the switch control circuit 400, the low voltage output terminal and the first diode 211 of the full wave bridge rectifier and the first voltage drop circuit 300, and flows back to the alternating current power supply. Similarly, after the bidirectional alternating current switch 100 is turned on, the bidirectional alternating current switch 100 may remain turned-on, and other circuits are shorted and stop outputting. In a case that the signal outputted by the alternating current power supply is in the positive half-cycle and the magnetic sensor 500 outputs a high level, or in a case that the signal outputted by the alternating current power supply is in the negative half-cycle and the magnetic sensor 500 outputs a low level, neither the first switch K1 nor the second switch K2 in the switch control circuit 400 can be turned on, and the bidirectional alternating current switch 100 is turned off for the reason that there is no drive current. As shown in FIG. 19C and FIG. 19D, a current flows through the motor, the rectifying circuit 200, the magnetic sensor 500, the first voltage drop circuit 300 and the second voltage drop circuit 600, and the current is lower than a current flowing through the motor and the first voltage drop circuit 300 in a case that there is a drive current for the bidirectional alternating current switch. Therefore, the switch control circuit 400 can switch, based on a polarity variation of the alternating current power supply and the magnetic inductive signal, the bidirectional alternating current switch 100 between an on-state and an off-state in a pre-determined manner, and control an power mode of the stator winding 16, so that a varying magnetic field generated by the stator adapts to a position of the magnetic field of the rotor and drives the rotor to rotate in a single direction, therefore the rotor rotates in a fixed direction every time the motor is powered.

In conclusion, the motor driving circuit according to the embodiments of the present disclosure includes the bidirectional alternating current switch 100, the rectifying circuit 200, the first voltage drop circuit 300, the switch control circuit 400, the magnetic sensor 500 and the second voltage drop circuit 600. The magnetic sensor 500 is configured to detect the external magnetic field and output the corresponding magnetic inductive signal. The switch control circuit 100 is configured to switch, at least based on the magnetic inductive signal, the switch control circuit 400 at least between the first state and the second state, so that the rotor of the motor in the motor component rotates in a same direction every time the motor is started.

The motor component according to the embodiments of the present disclosure may be applied to but not limited to a device such as a pump, a fan, a household appliance and a vehicle. The household appliance may be a washing machine, a dish-washing machine, a smoke exhauster, an exhaust fan, and so on.

It should be noted that, although the embodiments of the present disclosure are illustrated by taking the motor driving circuit applied to the motor as an example, an application field of the motor driving circuit according to the embodiments of the present is not limited hereto.

The sections of the disclosure are described in a progressive way, the differences from other parts are emphatically illustrated in each of the sections, and reference can be made to other sections for understanding the same or similar parts.

It should be noted that, relational terms in the present disclosure such as the first or the second are only used to differentiate one entity or operation from another entity or operation, rather than requiring or indicating any actual relation or sequence among the entities or operations. In addition, terms such as “include”, “comprise” or any other variants are intended to be non-exclusive, so that the process, method, item or device including a series of elements not only includes the elements but also includes other elements which are not specifically listed or the inherent elements of the process, method, item or device. With no more limitations, the element restricted by the phrase “include a . . . ” does not exclude the existence of other same elements in the process, method, item or device including the element.

The above descriptions of the disclosed embodiments enable those skilled in the art to implement or use the present disclosure. Various changes to the embodiments are apparent to those skilled in the art, and general principles defined herein may be implemented in other embodiments without departing from the spirit or scope of the present disclosure. Therefore, the present disclosure is not limited to the embodiments disclosed herein but is to conform to the widest scope consistent with the principles and novel features disclosed herein.

1. A motor driving circuit comprising:
an alternating current switch connected in series with a motor across two terminals of an external alternating current power supply, wherein the alternating current switch is connected between a first node and a second node;
a rectifying circuit having a first input terminal and a second input terminal; and
a first voltage drop circuit connected between the first input terminal of the rectifying circuit and the first node.

2. The motor driving circuit according to claim 1, further comprising a switch control circuit and a magnetic sensor, the switch control circuit connected between a control terminal of the alternating current switch and an output terminal of the rectifying circuit, wherein an output terminal of the magnetic sensor is connected to a control terminal of the switch control circuit and the magnetic sensor is configured to detect a magnetic field of a rotor of the motor and output a corresponding magnetic inductive signal.

3. The motor driving circuit according to claim 1, wherein a current flowing through the first voltage drop circuit when a drive current drives the alternating current switch has a drive current is higher than a current flowing through the first voltage drop circuit when the alternating current switch is turned off.

4. The motor driving circuit according to claim 1, wherein a current flowing through the motor when a drive current drives the alternating current switch is higher than a current flowing through the motor when the alternating current switch is turned off.

5. The motor driving circuit according to claim 1, further comprising a second voltage drop circuit provided between the second input terminal of the rectifying circuit and the second node.

6. The motor driving circuit according to claim 2, wherein the switch control circuit is configured to control, based on the magnetic inductive signal and a polarity of the alternating current power supply, the alternating current switch to be turned on or turned off.

7. The motor driving circuit according to claim 2, wherein the switch control circuit is configured to turn on the alternating current switch in a case that the alternating current power supply is in a positive half-cycle and the magnetic field of the rotor is in a first polarity, or in a case that the alternating current power supply is in a negative half-cycle and the magnetic field of the rotor is in a second polarity opposite to the first polarity, and to turn off the alternating current switch in a case that the alternating current power supply is in a negative half-cycle and the magnetic field of the rotor is in the first polarity, or in a case that the alternating current power supply is in a positive half-cycle and the magnetic field of the rotor is in the second polarity.

8. The motor driving circuit according to claim 2, wherein the switch control circuit at least switches between a first state and a second state in a case that the alternating current switch is in a on-state;
Wherein the first state is a situation that a current flows from a high voltage output terminal of the rectifying circuit to the control terminal of the alternating current switch through the switch control circuit; and the second state is a situation that a current flows from the control terminal of the alternating current switch to a low voltage output terminal of the rectifying circuit through the switch control circuit.

9. The motor driving circuit according to claim 8, wherein an operating state of the switch control circuit is the first state in a case that a polarity of the magnetic field of the rotor is a first polarity and the alternating current power supply operates in a positive half-cycle, and the operating state of the switch control circuit is the second state in a case that the polarity of the magnetic field of the rotor is a second polarity opposite to the first polarity and the alternating current power supply operates in a negative half-cycle.

10. The motor driving circuit according to claim 2, wherein the switch control circuit comprises a first switch and a second switch;
the first switch is connected in a first current path, and the first path is provided between the control terminal of the alternating current switch and a high voltage output terminal of the rectifying circuit; and
the second switch is connected in a second current path, and the second current path is provided between the control terminal of the alternating current switch and a low voltage output terminal of the rectifying circuit.

11. The motor driving circuit according to claim 2, wherein a power input terminal of the magnetic sensor is connected to a high voltage output terminal of the rectifying circuit, and a grounded terminal of the magnetic sensor is connected to a low voltage output terminal of the rectifying circuit.

12. The motor driving circuit according to claim 2, wherein the switch control circuit comprises a first current path in which a current flows to the control terminal of the alternating current switch, a second current path in which a current flows from the control terminal of the alternating current switch, and a switch connected in one of the first current path and the second current path, and the switch is controlled by the magnetic inductive signal to turn on the first current path and the second current path selectively.

13. The motor driving circuit according to claim 12, wherein there is no switch in the other one of the first current path and the second current path.

14. The motor driving circuit according to claim 2, wherein an input terminal of the switch control circuit is connected to a high voltage output terminal of the rectifying circuit, and an output terminal of the switch control circuit is connected to the control terminal of the alternating current switch; and
a power input terminal of the magnetic sensor is connected to the high voltage output terminal of the rectifying circuit, a grounded terminal of the magnetic sensor is connected to a low voltage output terminal of the rectifying circuit, and the output terminal of the magnetic sensor is connected to the control terminal of the switch control circuit.

15. The motor driving circuit according to claim 14, wherein in a case that the alternating current power supply operates in a positive half-cycle and a polarity of the magnetic field of the rotor is a second polarity, or in a case that the alternating current power supply operates in a negative half-cycle and the polarity of the magnetic field of the rotor is a first polarity, a path is formed between the power input terminal of the magnetic sensor and the grounded terminal of the magnetic sensor; and
in a case that the alternating current power supply operates in a negative half-cycle and the polarity of the magnetic field of the rotor is the second polarity, a path is formed between the output terminal of the magnetic sensor and the grounded terminal of the magnetic sensor.

16. The motor driving circuit according to claim 14, wherein the switch control circuit is configured as follows:
in a case that the alternating current power supply operates in a positive half-cycle and a polarity of the magnetic field of the rotor is a first polarity, a path is formed between the input terminal of the switch control circuit and the output terminal of the switch control circuit; and
in a case that the alternating current power supply operates in a negative half-cycle and the polarity of the magnetic field of the rotor is a second polarity, a path is formed between the output terminal of the switch control circuit and the control terminal of the switch control circuit.

17. The motor driving circuit according to claim 1, wherein the motor is connected in series with the alternating current power supply between the first node and the second node.

18. The motor driving circuit according to claim 1, wherein the motor is connected in series with the alternating current switch between the first mode and the second node.

19. A motor component comprising a motor and a motor driving circuit according to claim 1.

20. The motor component according to claim 19, wherein the motor comprises a stator and a rotor, and the stator comprises a stator core and a single-phase winding wound on the stator core.
